(19) United States
(12) Patent Application Publication
(10) Pub. No.: US 2024/0092671 A1
(43) Pub. Date: Mar. 21, 2024

(54) METHOD FOR TREATING GLASS WASTE

(71) Applicant: SAINT-GOBAIN ISOVER, COURBEVOIE (FR)

(72) Inventors: Guillaume DUPEUX, PARIS (FR); Guillaume BARBA ROSSA, COMPIEGNE (FR)

(73) Assignee: SAINT-GOBAIN ISOVER, COURBEVOIE (FR)

(21) Appl. No.: 18/038,843

(22) PCT Filed: Nov. 26, 2021
(86) PCT No.: PCT/FR2021/052108

§ 371 Date: May 25, 2023

(30) Foreign Application Priority Data
Nov. 30, 2020 (FR) 2012400

(51) Int. Cl. C03B 5/00; C03B 5/235

(52) U.S. Cl. CPC C03B 5/005; C03B 5/2353

(57) ABSTRACT

The present invention relates to a method for producing mineral material suitable for use as raw material in a glass melting method, comprising:
supplying a main tank with a vitrifiable mixture of materials comprising recycling materials comprising organic matter;
melting the vitrifiable mixture of materials in the main tank using submerged burners to obtain a melt; and
introducing a solid oxidant into the melt.

The present invention relates to a method for treating glass waste. It relates more particularly to a method for recycling glass-based materials having a significant proportion of organic matter to form a mineral material suitable for use as a vitrifiable raw material in a glass melting method.

It is known to recycle glass waste containing organic components by reintroducing this waste into methods for producing glass products. The presence of organic compounds may however have an impact on the quality of the melting and/or of the glass obtained. In general, the prior removal of the organic components is carried out, for example by combustion, before feeding the raw materials into the melting furnaces. More recently, the development of submerged burners has made it possible to dispense with this step. Melting with submerged burners indeed enables the combustion of organic components introduced with the raw materials to be recycled into the core of the molten glass. However, it has been noted that the glass obtained by this method could have mediocre quality, in particular due to the presence of inclusions of carbon particles.

It has also been noted that the recycling of glass waste containing organic matter directly in the methods for producing glass products tends to disturb the melting and shaping conditions of the products, which has the effect of limiting the amount of waste that can be introduced into these methods.

In order to improve the effectiveness of recycling glass waste containing organic matter, the present invention proposes a method for producing mineral material, such as cullet, which has a sufficient quality to be able to be used as raw material in glass melting methods without significantly disrupting the melting or shaping conditions of the glass.

Thus, a first aspect of the present invention relates to a method for producing mineral material suitable for use as raw material in a glass melting method, comprising:
supplying a main tank with a vitrifiable mixture of materials comprising recycling materials comprising organic matter;
melting the vitrifiable mixture of materials in the main tank using submerged burners to obtain a melt; and
introducing a solid oxidant into the melt.

The use of submerged burners has the advantage both of being able to provide a large amount of oxygen to the core of the melt, and to stir the melt thoroughly, promoting thus the homogenization of the mixture and the digestion of any contaminants. However, this proves to be insufficient, in particular in the case of recycling glass-based materials comprising large amounts of organic matter. Even when supplying a large amount of oxygen, the mineral material produced has significant quantities of carbon particles, resulting from partial combustion of the organic compounds. Likewise, it has been found impossible to control or even lower the redox of the mineral material produced with the only use of submerged burners. It has been noted that, when it is used in melting methods, a mineral material having a high redox is likely to create a foam on the surface of the glass bath. Without wishing to be bound to any theory, it is assumed that ferrous iron (FeO) is reacting with the sulfate contained in certain raw materials, for example the cullet of flat glass, and is producing SO₂ gas that forms a foam on the surface of the glass bath. The presence of this foam layer deteriorates the effectiveness of the energy transfers in the furnace.

It has been noted that the combined use of submerged burners and a solid oxidant made it possible to significantly improve the quality of mineral material produced, in particular by significantly reducing, or even avoiding the presence of carbon particles in the mineral material produced, such that the latter can be used in the melting methods of the glass without risk of disruption thereof.

The vitrifiable mixture of materials typically comprises at least 50%, preferably at least 70%, more preferentially at least 80%, indeed even at least 90% by weight of recycling materials. Conventional raw materials, derived in particular from natural resources, may be added to the vitrifiable mixture of materials, in particular to adjust the composition of the mineral material produced. In one embodiment, the vitrifiable mixture of materials is composed 100% of recycling materials. Examples of recycling materials that can be used in the method according to the invention comprise glass- or ceramic-based recycling materials comprising organic matter, such as waste fibers or mineral wool, in particular bound by an organic binder, the household cullet, often contaminated with organic waste, the waste of laminated glass, etc. In certain embodiments, the vitrifiable mixture of materials can come from a single source of recycling materials, in particular mineral wool waste, glass fiber waste, or laminated glass waste. The vitrifiable mixture of materials typically has at least 1%, preferably at least 2%, more preferentially at least 5% by weight of organic matter and typically up to 30%, or even up to 25%, or even up to 20% by weight of organic matter based on the total weight of the vitrifiable mixture of materials. The amount of organic matter can be determined by measuring the loss on ignition at 650° C. (variation in mass, expressed as a percentage by weight of the dry matter, resulting from heating to 650° C.). A high quantity of organic matter has the advantage of contributing, by its combustion, to providing the energy necessary for melting the vitrifiable mixture of materials, thus making it possible to reduce the quantity of fuel supplied by the burners. The recycling materials may also comprise metal pollution, for example iron or copper, in particular coming from construction waste. The mixture of raw material may thus comprise at least 0.2%, or even at least 0.5% by weight of metal particles.

The chemical composition, expressed in the form of oxides, of the vitrifiable mixture of materials is not particularly limited. It may in particular comprise a high iron content, typically having a total iron content, expressed in the form of Fe₂O₃, greater than 2%, preferably greater than 3%, or even greater than 4% by weight and preferably less than 10%, less than 8%. It may also be a composition with a low iron content, typically having a total iron content, expressed in the form of Fe₂O₃, less than 2%, preferably less than 1.7%, more preferentially less than 1.5%, or even less than 1% by weight. It has indeed been noted that the lower the iron content, the more difficult it is to control the redox of the mineral material produced. The method according to the invention allows easier control of the redox of the mineral material produced, including for compositions with a low iron content.

In certain embodiments, the vitrifiable mixture of materials can have a composition which contains the constituents below, in the proportions by weight based on the mineral part of the vitrifiable mixture of materials, defined by the following definite limits:

| | |
|---|---|
| SiO₂ | 35 to 80%, |
| Al₂O₃ | 0 to 30%, |
| CaO + MgO | 2 to 35%, |
| Na₂O + K₂O | 0 to 30%. |

wherein the sum of the SiO₂ and Al₂O₃ content is typically from 50 to 80% by weight.

Preferably, the vitrifiable mixture of materials has a composition which contains the constituents below, in the proportions by weight based on the mineral part of the vitrifiable mixture of materials, defined by the following limits:

| | |
|---|---|
| SiO₂ | 50 to 75%, |
| Al₂O₃ | 0 to 8%, |
| CaO + MgO | 2 to 20%, |
| Fe₂O₃ | 0 to 2%, |
| Na₂O + K₂O | 12 to 20%. |
| B₂O₃ | 0 to 10%. |

The vitrifiable mixture of materials is introduced into a main tank, preferably using a batch charger. The charging is advantageously a deep charging, that is charging of the vitrifiable mixture of materials below the level of the melt. An example of a batch charger for deep charging is described for example in WO2012132184.

The main tank constitutes a furnace with Submerged burners, often designated by the name SBM (Submerged Burner Melter) or SCM (Submerged Combustion Melter). The main tank may be a refractory wall tank conventionally used in the melting of the glass. Alternatively, the main tank may be a tank referred to as water jacket, comprising bare metal walls, that is to say not protected by refractory materials, which are traversed by a system of internal pipes wherein a cooling liquid is circulated, for example water. The main tank comprises one or more submerged burners. An example of a submerged burner melter suitable for the present invention is described in document WO2013186480.

“Submerged burners” means burners configured in such a way that the flames that they generate develop within the melt. They are generally arranged so as to be flush with the bottom. The submerged burners used in the context of the present invention may be cylindrical in shape as shown for example in FIG. 5 of WO9935099 or of linear shape as described for example in WO2013117851.

The submerged burners are fed with fuel and oxidant. The oxidant feeding the submerged burner is gaseous. It preferably comprises at least 80% by volume of oxygen. This is typically air enriched with oxygen, or pure oxygen. The fuel, typically gaseous, feeding the submerged burner is generally natural gas. The fuel/oxidant mixture may be a lean fuel mixture, that is having a stoichiometric oxygen/fuel molar ratio. The excess oxygen may in part contribute in part to the oxidation of the organic matter contained in the vitrifiable mixture of materials. Alternatively, at least a portion of the oxygen can be provided by separate bubblers of the submerged burners. The bubblers are generally also arranged at the bottom of the main tank. The ratio between the volume flow rate of oxygen and that of the fuel gas is typically at least 2, preferably 2.1 to 3.5.

However, it has been observed that even with high-oxygen stoichiometry, it was impossible to dispense with the presence of carbon particles during melting of raw materials comprising large amounts of organic matter. The addition of a solid oxidant in combination with melting using submerged burners, preferably in excess oxygen through super-stoichiometric supply of oxygen to the submerged burners or introduction of oxygen using oxygen bubblers, makes it possible to overcome this disadvantage.

Solid oxidant, typically in powder or granular form, can be chosen from nitrates, in particular sodium nitrate, sulfates, in particular sodium or calcium sulfates (in all their hydration forms), potassium dichromate, peroxides, in particular potassium or calcium peroxides, cerium oxide and manganese oxides, in particular manganese dioxide (MnO₂), manganese(III) oxide (Mn₂O₃), manganese(II, III) oxide (Mn₃O₄) and permanganates in particular of sodium, potassium, calcium or magnesium. Preferably, the solid oxidant is chosen from manganese oxides, in particular manganese dioxide. It may optionally be provided in the form of a chemical product, ore or by recycling materials, in particular plaster-based materials in the case of calcium sulphate. In certain embodiments, the solid oxidant is not selected from sulfates. Their use as an oxidant indeed causes an increase in the emissions of sulfur oxides (SOx) in the flue gases, which are to be avoided from an environmental point of view and involve expensive treatment facilities.

The solid oxidant can be added directly to the main tank. It can then be introduced as a mixture with the vitrifiable mixture of materials. Alternatively, it may be introduced by a separate batch charger arranged on a side wall of the main tank.

In a preferred embodiment, the method according to the invention comprises the transfer of the melt from the main tank to an auxiliary tank, the solid oxidant being introduced downstream of the main tank. The solid oxidant can then be introduced during the transfer of the melt, typically into the feeder channel of the auxiliary tank, for example by a batch charger located on the segment of the supply channel. Alternatively, the solid oxidant can be introduced directly into the auxiliary tank, for example by a batch charger located on a side wall of the auxiliary tank.

Regardless of how the solid oxidant is introduced, it is generally added at a concentration of 0.5 to 8%, preferably 1 to 5%, by weight relative to the flow rate of the vitrifiable mixture of materials. The introduction of the solid oxidant can be done continuously or intermittently. In the case of intermittent introduction, the added quantity is expressed as an average quantity over the average residence time of the melt in the tank wherein the oxidant is added.

The nature of the auxiliary tank is not particularly limited. It may be a tank with a refractory wall or a tank called a water jacket. It typically comprises heating means which may notably be chosen from electrodes, overhead burners, submerged burners or combinations thereof. The melt is preferably maintained at a temperature of 1000 to 1300° C., preferably 1050 to 1250° C.

The auxiliary tank advantageously comprises means for agitating the melt. These may be chosen from bubblers, typically fed with air, oxygen-enriched air, or oxygen, mechanical mixers, or submerged burners. The agitation means allow a homogeneous mixture of the solid oxidant in the melt, in particular creating intense zones of agitation in the auxiliary tank. The auxiliary tank according to the invention is therefore not suitable for refining. In a preferred embodiment, the auxiliary tank comprises one or more submerged burners. Indeed, it has been surprisingly observed that the use of burners submerged at the auxiliary tank allows both better control of the redox of the formed mineral material and achievement of lower redox values. Without wishing to be bound to any theory, it is assumed that the agitation induced by the submerged burners allows improved homogenization of the solid oxidant and promotes a rapid reaction of the latter with the melt.

The method according to the invention makes it possible to obtain a mineral material, typically cullet, derived from recycling materials having a higher quality in terms of limiting the quantity of carbon particles and to control the redox.

The method according to the invention makes it possible to obtain a mineral material, typically cullet, derived at least partially from recycling materials having a higher quality in terms of limiting the quantity of carbon particles and to control the redox. The present invention thus also relates to a mineral material capable of being used as a raw material in a glass melting method, capable of being obtained by the method according to the invention, derived, at least in part, from recycling materials comprising organic matter, and essentially free of carbon particles.

The mineral material according to the invention is preferably cullet derived mainly from recycling materials (typically at least 50%, preferably at least 70%, more preferentially at least 80%, indeed even at least 90% by weight) intended to be used as a raw material in a melting method. It may be hot cullet, that is in liquid form (typically a bath of molten glass), or cold cullet, that is in solid form (typically ground or granulated glass particles).

The mineral material according to the invention is essentially free of carbon particles. In this respect, it typically has a total carbon amount of less than 0.1%, preferably less than 0.05%, or even less than 0.01%. The total carbon amount is determined by melting the mineral material, typically at 1300° C., under a dioxygen atmosphere, and measuring the amount of carbon dioxide emitted by infrared spectrometry.

The mineral material typically has a redox of less than 0.95, preferably less than 0.9, more preferentially less than 0.7, or even less than 0.5, for example 0.1, even 0.15, or even 0.2 to 0.9, or even 0.7, or even 0.5, for example 0.1 to 0.9 or 0.2 to 0.7. In a particular embodiment, the mineral material may have a redox of 0.3, or even 0.5 to 0.9, or even 0.7. In another embodiment, the mineral material may have a redox of 0.1, or even 0.15 to 0.5, or even 0.3. Redox corresponds to the weight ratio between the ferrous iron content (Fe 2+), expressed in Fe₂O₃, and the total iron content, expressed in Fe₂O₃.

The mineral material typically has a volume fraction of bubbles of at least 0.05. The volume fraction of bubbles B can be determined by evaluating the apparent density of a glass block ρ_{bulk} with respect to the density of the glass ρ_{glass} according to formula B=1−(ρ_{bulk}/ρ_{glass}).

The mineral material typically has a composition which comprises the following constituents, in the weight proportions, defined by the following limits:

| | |
|---|---|
| SiO₂ | 35 to 80%, |
| Al₂O₃ | 0 to 30% |
| CaO + MgO | 2 to 35%, |
| Na₂O + K₂O | 0 to 30%. |

wherein the sum of the SiO₂ and Al₂O₃ content is preferably from 50 to 80% by weight.

Preferably, the mineral material typically has a composition which comprises the following constituents, in the weight proportions defined by the following limits:

| | |
|---|---|
| SiO₂ | 50 to 75%, |
| Al₂O₃ | 0 to 8%, |
| CaO + MgO | 2 to 20%, |
| Fe₂O₃ | 0 to 2%, |
| Na₂O + K₂O | 12 to 20%. |
| B₂O₃ | 0 to 10%. |

By limiting the amount of carbon particles and controlling the redox, the mineral material according to the invention can advantageously be used as raw material in the glass melting methods, in particular in electrical melting, without risk of perturbation thereof. In particular, foam in the presence of sulfate-bearing raw materials can be avoided, and the increase of the melting temperature can be limited.

The present invention also relates to a method for manufacturing mineral wool comprising the provision of a melt to be fiberized and the fiberizing of the melt to be fiberized, characterized in that the melt to be fiberized is derived at least in part from the mineral material according to the invention or obtained by the method for producing mineral material according to the invention. In certain embodiments, the step of providing a melt comprises providing a mixture of raw material(s) and, if appropriate, melting the mixture of raw material(s) to obtain a melt to be fiberized, wherein the mixture of raw material(s) comprises at least 20%, preferably at least 50%, or even at least 70%, or even at least 80%, by weight of mineral material according to the invention or obtained by the method for producing mineral material according to the invention. In a particular embodiment, the mixture of raw material(s), and consequently the melt to be fiberized, is essentially composed of the mineral material according to the invention. The melt to be fiberized may be a hot cullet derived directly from the method for producing mineral material according to the invention. In this case, the method for manufacturing mineral wool comprises the production of mineral material according to the method described above, said mineral material being a molten mineral material, and the fiberizing of the molten mineral material. In particular, the mineral material is preferably conveyed to a fiberizing member at the outlet of the auxiliary tank. Alternatively, the melt can be obtained by melting a cold cullet resulting from the method for producing mineral material according to the invention. In this case, the method for manufacturing mineral wool comprises the production of mineral material according to the method described above, the mineral material being a solid mineral material, the melting of the solid mineral material in order to obtain a melt to be fiberized, and the fiberizing of the melt to be fiberized.

The fiberizing may be carried out by any method known to a person skilled in the art. It may in particular be a fiberizing method by external centrifugation or by internal centrifugation. The external centrifugation methods typically use a cascade of centrifuging wheels supplied with melt to be fiberized by a dispensing device, as described for example in applications EP 0465310 or EP 0439385. In internal centrifugation methods, a stream of melt to be fiberized is introduced into a fiberizing dish, rotating at high speed and pierced around its periphery by a very large number of orifices through which the glass is ejected in the form of filaments owing to the effect of the centrifugal force. These filaments are then subjected to the action of an annular pull current at high temperature and high speed hugging the wall of the spinner, which current thins them and transforms them into fibers. The fiberizing is preferably carried out by internal centrifugation, in particular using a fiberizing member as described in application FR 1382917.

The present invention finally relates to a mineral wool obtained directly from the mineral material according to the invention or from the mineral material obtained by the method for producing mineral material according to the invention. In other words, the mineral wool is obtained from a melt composed of the mineral material according to the invention or of the mineral material obtained by the method for producing mineral material according to the invention. As such, the mineral wool according to the invention has the same composition as the mineral material according to the invention. The characteristics of composition (including the total carbon content and redox) described for the mineral material therefore also apply to the mineral wool according to the invention. In particular, the mineral wool according to the invention is characterized in that it is derived at least in part from recycling materials comprising organic matter and that it is essentially free of carbon particles.

The present invention is shown by the following nonlimiting examples.

In each of the following examples, a vitrifiable mixture of materials consisting of 100% of ground mineral wool waste comprising 8% by weight of organic compounds is introduced using a batch charger in a submerged burner furnace.

A first series of examples (C1, I1 and I2) is made in an SBM furnace comprising a main tank with refractory walls (R) of a 0.5 m² surface and a submerged burner of 150 kW supplied with an oxygen/natural gas mixture with a ratio between the volume flow rate of oxygen and that of natural gas of 2.5. In these three examples, the main tank furthers comprises oxygen bubblers fed with an oxygen flow rate of 30 Nm³/h. The furnace has a draw of 10 t/d.

A second series of examples (C2, I3 and I4) is made in an SBM furnace comprising a main tank with refractory walls, called a water jacket (WJ), with a surface area of 0.3 m² and three 110 kW submerged burners supplied with an oxygen/natural gas mixture with a ratio between the volume flow rate of oxygen and that of natural gas of 2.5. The furnace has a draw of 3 t/d.

In example 11 according to the invention, manganese oxide (MnO₂) is introduced into the main tank mixed with the ground mineral wool.

In examples I2 to I4 according to the invention, the melt obtained at the outlet of the main tank is transferred into an auxiliary tank and manganese oxide (MnO₂) is introduced at the feeder channel of the auxiliary tank. In example I2, the auxiliary tank is a refractory-wall tank (R) equipped with a submerged burner similar to the main tank. In examples I3, the auxiliary tank is a refractory tank (R) equipped with air burners and bubblers on the flow path of the melt. In example I4, the auxiliary tank is a tank called a water jacket (WJ) with submerged burners similar to the main tank.

In each of the examples I1 to I4, the manganese oxide is introduced at a level of 2% by weight of the draw, that is a mass flow rate of 8.3 kg/h for 11 and 12 and 2.5 kg/h for 13 and 14.

Examples C1, C2 are comparative examples wherein no solid oxidizing agent has been introduced.

The melt is recovered at the outlet of the main tank (C1, C2 and I1) or of the auxiliary tank (I2, I3 and I4) in the form of cullet. The cullet compositions produced and the properties thereof are summarized in the table 1.

The presence of carbon particles is determined by visual observation: “+” indicates the presence of carbon particles visible to the naked eye and “−” the absence of carbon particles visible to the naked eye.

The total amount of carbon is determined by melting the mineral material at 1300° C. under a dioxygen atmosphere, and measuring the amount of carbon dioxide emitted by infrared spectrometry.

Redox is determined by wet FeO analysis.

TABLE 1

| ² | C1 | C2 | I1 | I2 | I3 | I4 |
|---|---|---|---|---|---|---|
| Main tank | R | WJ | R | R | WJ | WJ |
| Auxiliary tank | − | − | − | R | R | WJ |
| Auxiliary tank mixers | − | − | − | SB | B | SB |
| O₂/natural gas ratio | 2.5 | 2.5 | 2.5 | 2.5 | 2.5 | 2.5 |
| Additional O₂ flow rate | 30 ^{a)} | − | 30 ^{a)} | 30 ^{a)} | − | − |
| (Nm3/h) | | | | | | |
| Added MnO2 (% drawn) | — | — | 2 ^{b)} | 2 ^{c)} | 2 ^{c)} | 2 ^{c)} |
| Redox | 0.9 | 1 | 0.9 | 0.4 | 0.6 | 0.2 |
| Carbon particles | + | + | − | − | − | − |
| Total carbon (%) | >>0.1 | >>0.1 | <0.1 | <0.1 | <0.1 | <0.1 |

R: refractory tank
WJ: water jacket tank
SB: submerged burner
B: bubblers
^{a)} in the main tank
^{b)} in the main tank with the vitrifiable mixture of materials
^{c)} in the supply channel between the main tank and the secondary tank

Compared to the cullets obtained in examples C1 and C2, the cullets of examples I1 to I3 according to the invention prove to be better quality not only because they are essentially free of carbon particles, but also due to better control of the redox. In particular, the introduction of the oxidant downstream of the main tank, as in examples I2 to I4, makes it possible, depending on the quantity of oxidant introduced, to adjust the desired redox to relatively low values.

1. A method for producing mineral material suitable for use as raw material in a glass melting method, comprising:
supplying a main tank with a vitrifiable mixture of materials comprising recycling materials comprising organic matter;
melting the vitrifiable mixture of materials in the main tank using submerged burners to obtain a melt; and
introducing a solid oxidant into the melt.

2. The method according to claim 1, wherein the chemical composition of the vitrifiable mixture of materials, expressed in the form of oxides, comprises less than 2% by weight of total iron oxide, expressed in the form of Fe₂O₃.

3. The method according to claim 1, wherein the chemical composition of the vitrifiable mixture of materials, expressed in the form of oxides, comprises 2 to 10% by weight of total iron oxide, expressed in the form Fe₂O₃.

4. The method according to claim 1, wherein the recycling materials are chosen from mineral wool waste, household cullet and laminated glass waste.

5. The method according to claim 1, wherein the solid oxidant is chosen from nitrates, sulfates, and manganese oxides.

6. The method according to claim 1, further comprising transferring the melt from the main tank to an auxiliary tank, the solid oxidant being introduced downstream of the main tank.

7. The method according to claim 1, wherein the auxiliary tank comprises an agitator.

8. A mineral material capable of being used as a raw material in a glass melting method, obtained by the method of claim 1, wherein the mineral material is made at least in part from recycling materials comprising organic matter, and wherein the mineral material is essentially free of carbon particles.

9. The mineral material according to claim 8, which is a cullet.

10. The mineral material according to claim 8, which has a total carbon amount of less than 0.1%.

11. The mineral material according to claim 8, which has a redox from 0.1 to 0.9.

12. A method for manufacturing mineral wool comprising the provision of a melt to be fiberized and the fiberizing of the melt to be fiberized, wherein the melt to be fiberized is made at least in part from the mineral material obtained by the method according to claim 1.

13. A mineral wool obtained directly from the mineral material obtained by the method according to claim 1, which is made at least in part from recycling materials comprising organic matter and which is essentially free of carbon particles.

14. The mineral wool according to claim 13, which has a total carbon amount of less than 0.1%.

15. The mineral wool according to claim 13, which has a redox from 0.1 to 0.9.

16. The method according to claim 5, wherein the solid oxidant is sodium nitrate.

17. The method according to claim 5, wherein the solid oxidant is sodium sulfate or calcium sulfate.

18. The method according to claim 5, wherein the solid oxidant is manganese dioxide.
